(19) United States
(12) Patent Application Publication
(10) Pub. No.: US 2019/0279436 A1
(43) Pub. Date: Sep. 12, 2019

(54) SERVER FOR MANAGEMENT SYSTEM, MANAGEMENT METHOD, AND NON-TRANSITORY COMPUTER RECORDING MEDIUM

(71) Applicant: Toyota Jidosha Kabushiki Kaisha, Toyota-shi Aichi-ken (JP)

(72) Inventors: Masahiro Nakano, Nagoya-shi (JP); Kazuya Nishimura, Okazaki-shi (JP)

(73) Assignee: Toyota Jidosha Kabushiki Kaisha, Toyota-shi (JP)

(21) Appl. No.: 16/296,726

(22) Filed: Mar. 8, 2019

(30) Foreign Application Priority Data
Mar. 12, 2018 (JP) 2018-044612

(51) Int. Cl. G07B 15/02; G06Q 10/02; G06Q 50/30; G06Q 30/06

(52) U.S. Cl. CPC G07B 15/02; G06Q 30/0645; G06Q 50/30; G06Q 10/02

(57) ABSTRACT

A server for a management system is provided. The server includes: a processor that receives a reservation for a shared car from a user's communication terminal via a communication network and determines whether a reservation time of the reserved shared car is greater than a threshold value; and a communication module that transmits a message for checking whether it is permitted to rent a parking area of the reserved shared car to a parking applicant while the user is using the reserved shared car to the user's communication terminal when the reservation time is greater than the threshold value.

### CROSS-REFERENCE TO RELATED APPLICATIONS

This application claims priority to Japanese Patent Application No. 2018-044612 filed on Mar. 12, 2018, which is incorporated herein by reference in its entirety including the specification, drawings and abstract.

### BACKGROUND

### 1. Technical Field

The disclosure relates to a server for a management system, a management method, and a non-transitory computer recording medium.

### 2. Description of Related Art

With advances in information communication technology or changes in lifestyle or for economic reasons, the age in which objects are owned by individual persons has changed to an age in which objects are shared by communities. In carsharing, shared cars can be shared by members and the members can ascertain a use state of a shared car or reserve use thereof using the Internet. Since the cost of purchasing a vehicle, maintenance costs, parking lot fees, and the like are reduced for users using this carsharing in comparison with a case in which a user owns a vehicle, the number of users who use the carsharing is increasing. On the other hand, know-how is required for a carsharing provider to make a profit. For example, the demand for carsharing in downtown areas with high land prices is higher than that in underpopulated areas with low land prices, but the maintenance costs for a parking lot in which shared cars are parked is higher and thus effective use of a parking lot is important. For such circumstances, Japanese Unexamined Patent Application Publication No. 2002-260027 (JP 2002-260027 A) proposes a technique of renting a vacant area of a parking lot which is freed when a contracted vehicle has left the parking lot to a parking applicant of a general vehicle.

### SUMMARY

However, a rentable time for renting a vacant area of a parking lot which is freed when a contracted vehicle has left the parking lot to a parking applicant of a general vehicle is limited to a period of time from the time at which the contracted vehicle leaves the parking lot to the time at which the contracted vehicle returns to the parking lot. Accordingly, when the period of time from a time at which a contracted vehicle leaves a parking lot to a time at which the contracted vehicle returns to the parking lot is short, there is insufficient need for renting the vacant area of the parking lot which is freed when the contracted vehicle has left the parking lot to a parking applicant of a general vehicle.

Therefore, the disclosure proposes a server for a management system that can achieve effective use of a parking area for a shared car.

According to an aspect of the disclosure, there is provided a server for a management system, the server including: a processor configured to receive a reservation for a shared car from a user's communication terminal via a communication network and to determine whether a reservation time of the reserved shared car is greater than a threshold value; and a communication module configured to transmit a message for checking whether it is permitted to rent a parking area of the reserved shared car to a parking applicant while the user is using the reserved shared car to the user's communication terminal when the reservation time is greater than the threshold value.

With the server for a management system according to the disclosure, it is possible to achieve effective use of a parking area for a shared car.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating functional blocks of a management system according to an embodiment of the disclosure; and

FIG. 2 is a flowchart illustrating a flow of a parking area reserving process according to the embodiment of the disclosure.

### DETAILED DESCRIPTION OF EMBODIMENTS

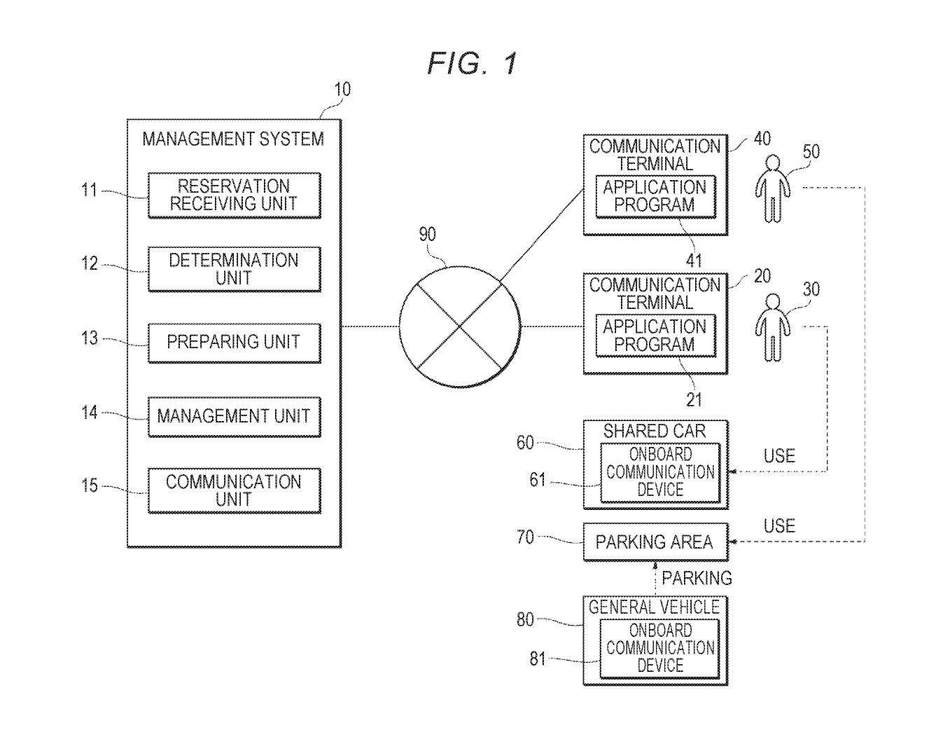

Hereinafter, an embodiment of the disclosure will be described with reference to the accompanying drawings. Here, the same reference signs refer to the same elements and repeated description thereof will be omitted. FIG. 1 is a diagram illustrating functional blocks of a management system 10 according to an embodiment of the disclosure. The management system 10 is a computer system that performs management of shared cars 60 (for example, management of reception of reservations for the shared cars 60 or rental and return thereof) and management of parking areas 70 of the shared cars 60 (for example, management of reservations for use of the parking areas 70). While a shared car 60 is being used, a parking area 70 for parking the shared car 60 is vacant and thus the management system 10 receives a reservation for use of the parking area 70 from a parking applicant 50 of a general vehicle 80. The shared cars 60 and the general vehicle 80 may include onboard communication devices 61 and 81 which are radio communication modules for radio connection to the management system 10. A user interface of each of the onboard communication devices 61 and 81 may be, for example, one of an operation key, a touch panel, and voice input or may be a combination thereof.

The management system 10 is a server computer (for example, a web server) that includes, for example, a processor, a storage device, and a communication module as hardware resources. Management programs for performing management methods of managing the shared cars 60 and the parking areas 70 thereof are stored in the storage device. By causing the processor to analyze and execute the management programs, functions of a reservation receiving unit 11, a determination unit 12, a preparing unit 13, a management unit 14, and a communication unit 15 are implemented. These are functions which are implemented through cooperation of the hardware resources of the management system 10 with the management programs. For example, the functions (or the processes) of the reservation receiving unit 11, the determination unit 12, the preparing unit 13, and the management unit 14 are implemented by the function (or the process) of the processor. The function (or the process) of the communication unit 15 is implemented by the function (the process) of the communication module. The storage device that stores the management programs is a computer-readable recording medium such as a semiconductor memory or a disk medium.

The management system 10, a communication terminal 20 of a user 30 who is a carsharing member, and a communication terminal 40 of a parking applicant 50 are connected to each other via a communication network 90. The communication network 90 is, for example, a communication network in which wired networks (for example, a local area communication network (LAN), a wide area communication network (WAN), and a value-added communication network (VAN)) and radio networks (for example, a mobile communication network, a satellite communication network, Bluetooth (registered trademark), wireless fidelity (WiFi), and high-speed downlink packet access (HSDPA)) are mixed.

The communication terminal 20 has an application program 21, which performs processes such as inputting, changing, and cancelling of a reservation for use of a shared car 60, installed therein. The communication terminal 40 has an application program 41, which performs processes such as inputting, changing, and cancelling of a reservation for use of a parking area 70, installed therein. The communication terminals 20 and 40 may be, for example, mobile communication terminals having a mobile communication function such as a multifunction mobile phone called a smartphone or a tablet terminal, or may be a personal computer having a communication function. A user interface of each of the communication terminals 20 and 40 may be one of a keyboard, a mouse, a touch panel, and voice input or may be a combination thereof.

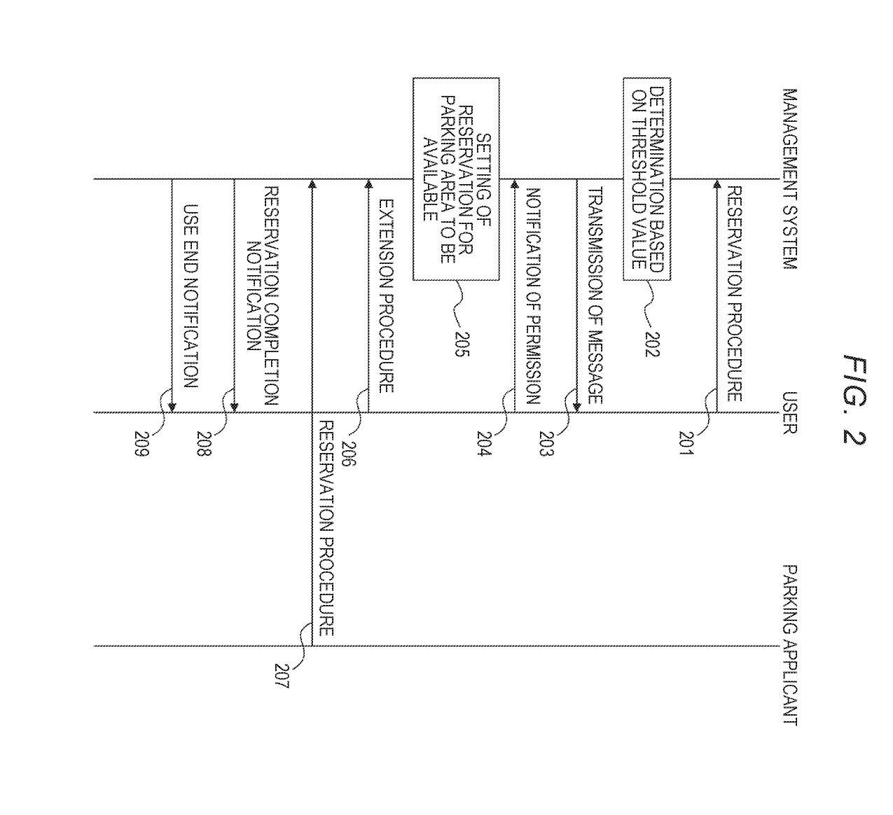

A flow of a process of reserving a parking area 70 will be described below with reference to FIG. 2 along with FIG. 1. The reservation receiving unit 11 performs a process of receiving a reservation for a shared car 60 from the communication terminal 20 of the user 30 via the communication network 90 (Step 201). This reservation receiving process includes a process of changing or cancelling the reservation for use of the shared car 60. In the reservation receiving process, availability of the shared cars 60 is displayed on a display of the communication terminal 20. The user 30 selects a shared car 60 that he or she desires to use with reference to the availability of the shared cars 60, and designates, for example, a use start time and a use time thereof.

The determination unit 12 determines whether a reservation time of the reserved shared car 60 is greater than a threshold value (Step 202). The threshold value can be set to, for example, a threshold time serving as a reference for determining whether the user time of the shared car 60 is long or short. When the reservation time is greater than the threshold value (for example, when it is determined that the use time of the shared car 60 is long), the preparing unit 13 prepares a message (for example, an electronic mail message or a voice message) for checking whether it is permitted to rent the parking area 70 of the reserved shared car 60 to a parking applicant 50 while the user 30 is using the reserved shared car 60. The communication unit 15 transmits the message to the communication terminal 20 via the communication network 90 (Step 203). The user 30 can transmit a notification indicating that rental of the parking area 70 is permitted or a notification indicating that rental of the parking area 70 is not permitted from the communication terminal 20 to the management system 10 via the communication network 90 in response to the message. The message may include, for example, a message indicating that a usage fee for the shared car 60 is discounted due to permission for rental of the parking area 70 to the parking applicant 50 by the user 30. Through an incentive which is discount of the usage fee for the shared car 60, it is possible to prompt rental of the parking area 70 to the parking applicant 50 by the user 30 and to expect an increase in profit due to rental of the parking area 70.

The management unit 14 performs a process of managing a reservation for use of a parking area 70 (for example, a process such as receiving, changing, or cancelling of the reservation for use of the parking area 70 and management of an available state of the parking area 70). In response to receiving the notification indicating that rental of the parking area 70 is possible from the communication terminal 20 by the communication unit 15 (Step 204), the management unit 14 sets a reservation state of the parking area 70 within the reservation time of the reserved shared car 60 to an available state in which use of the parking area by the parking applicant 50 is possible (Step 205). The user 30 may designate a period of time in which use of the parking area 70 by the parking applicant 50 is possible within the reservation time of the shared car 60 by operating the communication terminal 20 before starting use of the shared car 60 or while using the shared car 60. Alternatively, the user 30 may designate a period of time in which use of the parking area 70 by the parking applicant 50 is possible within the reservation time of the shared car 60 by operating the onboard communication device 61 of the shared car 60 while using the shared car 60. In this case, the management unit 14 sets the reservation state of the parking area 70 within the period of time designated by the user 30 as the period of time in which use of the parking area 70 by the parking applicant 50 is possible within the reservation time of the reserved shared car 60 to an available state in which use of the parking area by the parking applicant 50 is possible.

When the user 30 is using the shared car 60, the management unit 14 may receive an extension procedure of a vacant time in which use of the parking area 70 by the parking applicant 50 is possible from the communication terminal 20 of the user 30 or the onboard communication device 61 of the shared car 60 via the communication network 90 (Step 206). For example, when the user 30 cannot return to the parking area 70 by a scheduled use end time of the shared car 60 due to traffic congestion or the like and extension of the vacant time in which use of the parking area 70 by the parking applicant 50 is possible, it is profitable for both the user 30 and the parking applicant 50.

On the other hand, in response to receiving the notification indicating that rental of the parking area 70 is not permitted from the communication terminal 20 by the communication unit 15, the management unit 14 prohibits the parking applicant 50 from using the parking area 70 within the reservation time of the reserved shared car 60.

The management unit 14 performs a process of receiving a reservation for the parking area 70 from the communication terminal 40 of the parking applicant 50 or the onboard communication device 81 of the general vehicle 80 via the communication network 90 (Step 207). In this reservation receiving process, availability of one or more parking areas 70 is displayed on the display of the communication terminal 40 or the onboard communication device 81. The parking applicant 50 selects a parking area 70 that he or she desires to use with reference to the availability of the parking areas 70 and designates, for example, a use start time and a use time. When the process of reserving the parking area 70 is completed by the parking applicant 50 before the user 30 starts use of the shared car 60, the communication unit 15 transmits a notification indicating that a reservation for the parking area 70 by the parking applicant 50 has been completed to the communication terminal 20 of the user 30 along with information on the reservation time of the parking area 70 (Step 208). When the process of reserving the parking area 70 is completed by the parking applicant 50 while the user 30 is using the shared car 60, the communication unit 15 may transmit a notification indicating that the reservation for the parking area 70 by the parking applicant 50 has been completed to the communication terminal 20 of the user 30 or the onboard communication device 61 of the shared car 60 along with information on the reservation time of the parking area 70 (Step 208). By this notification, the user 30 can ascertain the use time of the parking area 70 by the parking applicant 50. When use of the parking area 70 by the parking applicant 50 ends, the communication unit 15 may transmit a notification indicating that use of the parking area 70 has ended to the communication terminal 20 of the user 30 or the onboard communication device 61 of the shared car 60 (Step 209). By this notification, the user 30 can ascertain end of use of the parking area 70 by the parking applicant 50.

According to the embodiment of the disclosure, by allowing the user 30 to check whether rental of the parking area 70 of the shared car 60 to the parking applicant 50 is permitted on the assumption that the reservation time of the shared car 60 is greater than a threshold value, it is possible to prohibit rental of the parking area 70 to the parking applicant 50 when use of the shared car 60 for a short time is expected and to rent the parking area 70 to the parking applicant 50 when use of the shared car 60 for a long time is expected. Accordingly, it is possible to achieve effective use of a parking area 70 for a shared car 60.

The above-mentioned embodiment is provided so that the disclosure can be easily understood and should not be construed as restrictive of the disclosure. The present disclosure can be changed or modified without departing from the gist thereof and the present disclosure includes equivalents thereof. For example, a management program may include a plurality of software modules which are called and executed by a main program. Such software modules are sub programs which are configured to perform a process of implementing the functions of the reservation receiving unit 11, the determination unit 12, the preparing unit 13, the management unit 14, and the communication unit 15. The same functions may be implemented using dedicated hardware resources (for example, an application-specific integrated circuit (ASIC) or a field programmable gate array (FPGA)) or firmware. The management program may be coded in a predetermined signal format and transmitted from one computer to another computer via a transmission medium (a wired communication network) or carrier waves (radio waves). The functions of the management system 10 do not need to be implemented by one computer and may be implemented by a plurality of computers which are connected to a communication network.

What is claimed is:

1. A server for a management system, the server comprising:
a processor configured to receive a reservation for a shared car from a user's communication terminal via a communication network and to determine whether a reservation time of the reserved shared car is greater than a threshold value; and
a communication module configured to transmit a message for checking whether it is permitted to rent a parking area of the reserved shared car to a parking applicant while the user is using the reserved shared car to the user's communication terminal when the reservation time is greater than the threshold value.

2. The server according to claim 1, wherein:
the processor is configured to manage a reservation for use of the parking area; and
the processor is configured to set a reservation state of the parking area in the reservation time of the reserved shared car to an available state in which use of the parking area by the parking applicant is possible in response to reception of a notification indicating that rental of the parking area is permitted from the user's communication terminal by the communication module.

3. The server according to claim 2, wherein:
the processor is configured to receive a reservation for use of the parking area from a communication terminal of the parking applicant or an onboard communication device of a general vehicle of the parking applicant via the communication network; and
the communication module is configured to transmit information on the reservation time of the reserved parking area to the user's communication terminal or an onboard communication device of the shared car which is used by the user.

4. The server according to claim 2, wherein the communication module is configured to transmit a notification indicting that use of the parking area has ended to the user's communication terminal or an onboard communication device of the shared car which is used by the user when use of the parking area by the parking applicant has ended.

5. The server according to claim 2, wherein the processor is configured to receive an extension procedure of a vacant time in which use of the parking area by the parking applicant is possible from the user's communication terminal or an onboard communication device of the shared car which is used by the user via the communication network.

6. The server according to claim 1, wherein the message includes a message indicating that a usage fee for the shared car is discounted due to permission of rental of the parking area to the parking applicant by the user.

7. A management method comprising:
receiving a reservation for a shared car from a user's communication terminal via a communication network;
determining whether a reservation time of the reserved shared car is greater than a threshold value; and
transmitting a message for checking whether it is permitted to rent a parking area of the reserved shared car to a parking applicant while the user is using the reserved shared car to the user's communication terminal when the reservation time is greater than the threshold value.

8. A non-transitory computer readable medium storing a program causing a computer to perform the management method according to claim 7.
